(19) United States
(12) Patent Application Publication
(10) Pub. No.: US 2025/0185126 A1
(43) Pub. Date: Jun. 5, 2025

(54) Estimating Motion of a Load Carrier

(71) Applicant: Samsung Electronics Co., Ltd., Suwon-si (KR)

(72) Inventors: Musa Maharramov, The Woodlands, TX (US); Brian Patton, San Francisco, CA (US); Pedro Martinez Lopez, Mountain View, CA (US)

(21) Appl. No.: 18/526,399

(22) Filed: Dec. 1, 2023

(51) Int. Cl. H05B 6/64; G06T 7/215; H05B 6/78

(52) U.S. Cl. CPC H05B 6/6455; G06T 7/215; H05B 6/6411; H05B 6/782; G06T 2207/10024; G06T 2207/10048; G06T 2207/30128

(57) ABSTRACT

In one embodiment, a method includes accessing an initial image of a load on a moving load carrier, the initial image of the load having been captured at an initial time, and accessing a subsequent image of the load at a subsequent time. The method further includes generating a transformed set of images including a first initial image and a first subsequent image, by transforming at least one of: (1) the initial image to the first initial image or (2) the subsequent image to the first subsequent image according to a motion profile of the load carrier from the initial time to the subsequent time. The method further includes estimating a motion of the load carrier from the initial time to the subsequent time based on minimizing a difference between the first subsequent image of the load and the first initial image of the load.

### TECHNICAL FIELD

This application generally relates to estimating motion of a load carrier.

### BACKGROUND

Moving load carriers are used in a wide variety of applications, including commercial, residential, and industrial applications. For example, a turntable or similar rotating load carrier is commonly found in microwave ovens. While the microwave oven is emitting microwave radiation, the turntable rotates, thereby rotating any load (e.g., a food item on a dish such as a plate) that is on the turntable. In this example, rotation of the load is used to reduce position-dependent discrepancies in the microwave radiation reaching the load.

As another example of a moving load carrier, some commercial food-processing applications involve performing quality control on loads by detecting thermal conditions (e.g., temperature) of the load as it moves along, or is pushed off of, a conveyor belt. Additional examples of the uses of moving load carriers include processes in industrial chemical equipment, nuclear equipment, and transportation, among many other applications.

### BRIEF DESCRIPTION OF THE DRAWINGS

FIG. 1 illustrates an example method for estimating the movement of a load carrier.

FIG. 2 illustrates an example graph of the objective function (16) at a single time in the example of cooking a food item on a microwave turntable.

FIG. 3 illustrates an example statistics of an estimated rotation rate of a rotating load carrier.

FIG. 4 illustrates a specific implementation of the example method of FIG. 1.

FIG. 5 illustrates an example computing system.

### DESCRIPTION OF EXAMPLE EMBODIMENTS

Moving load carriers are used in a wide variety of applications, including commercial, residential, and industrial applications. For example, rotating load carriers are commonly found in microwave ovens, conveyor belts, rotisserie spindles, and other mechanical systems. However, the amount of movement of a moving load carrier often cannot be predicted a priori. For example, a carrier designed to rotate at 3 rotations per minute may in fact rotate at a different rate, both at any point in time or on average over a given time period. For instance, a manufacturer's specifications for a motor may state that the motor rotates at a constant rate, but in practice the motor's rotation rate may deviate from the stated rotation rate by a constant bias, which may be specific to each particular motor unit (e.g., two motors of the same model and manufactured in the same plant in the same batch may nevertheless have a different bias). In addition, a load-carrier's rotation rate may vary temporally, including due to random noise, due to load-specific attributes (e.g., a heavy load may slow the rate of rotation), and/or due to varying conditions (e.g., a temporary stick-slip condition that is present due to a specific interaction between a load and a carrier). A carrier's rotation rate may exhibit oscillations, drift, or stuttering motion that varies as a function of load and/or as a function of time. Moreover, variable friction and electrical fluctuations may result in a rotation rate that is different than the designed value. Additionally, the rotation rate of a load carrier may change over time due to system design, assembly, maintenance, operating conditions, and/or the properties and physical placement of each load.

Uncertain movement creates a variety of problems when attempting to estimate a load's parameters. One example of the kind of problems uncertain rotation can create comes from load segmentation, for example of a food load in a microwave oven. A microwave that changes its control parameters (e.g., radiation intensity) based on the temperature of the food must be able to distinguish between regions of the microwave that contain food and the background (such as a plate the food rests on, the interior of the microwave, etc.). For example, suppose an RGB or thermal image of the interior of the microwave includes food portions and non-food portions in the image. An initial segmentation map between food and non-food regions can be made by processing image data from an initial image, but this segmentation map will be inaccurate for subsequent images as the food rotates on the carrier.

As one example of a masking approach to segmentation, it is possible to calculate an initial segmentation (e.g., food and non-food) mask for frozen food being defrosted in a microwave by measuring which pixels in the initial thermal image are associated with a temperature below 0° C. and which are associated with a temperature above 0° C. Frozen food has a temperature below 0° C. in the initial thermal image before any heat is applied, but after some defrosting time it is likely that some of the frozen food will have thawed to temperatures above 0° C. After heating, temperatures inside the load become highly uneven, making the threshold-based masking like that described above (e.g., threshold=0° C.) difficult or impossible. After heating, recalculating the mask according to the threshold criteria would then exclude the thawed regions, and a process designed to thaw the food gently may over-heat those portions of the load because it does not recognize them as food.

Continuing the example above, an initial mask of the food can be made, for example based on the threshold described above. If the food is on a turntable and the cameras are static, however, the resulting mask will become inaccurate as soon as the turntable begins rotating. Correct interpretation of the data from the RGB and/or thermal cameras therefore requires that the mask be updated for each subsequent image. One approach to updating the mask could be to recalculate the mask based on the RGB and/or thermal images each time a new image is captured (i.e. dynamic masking). However, dynamic masking is often impractical (e.g., due to computational requirements) and ineffective (e.g., due to changing load and/or background conditions that make masking over time difficult). In addition, in the example above, dynamic masking will not work once the food begins to thaw.

Another approach to updating the mask in the example above is to transform (e.g., rotate) the initial image of the mask (or the subsequent image of the food, or both). However, as explained above, the rotation rate of a load carrier is typically not known apriori. This disclosure therefore describes techniques and systems for accurately estimating the movement of a load carrier. This estimate can then be used to estimate any number of load statistics, such as the temperature distribution of a load exclusive of the background. As discussed throughout, the embodiments of this disclosure accurately estimate motion of a load carrier, often in real time. As described herein, in particular embodiments other load statistics are estimated from the movement estimates described herein.

As described herein, techniques and systems of this disclosure can be applied to a wide variety of moving load carriers and preclude the need for more expensive and more accurate carriers (e.g., precisely designed motors) in order to estimate a carrier's motion. The techniques described herein may be used by any suitable device including an appliance such as a microwave oven, rotisserie, or other consumer cooking appliance, and including transportation or processing equipment (such as turntables, linear conveyor systems, or other systems that transport material along a trajectory). A load generally refers to the object or material that is being processed or transported within the apparatus (such as the food being heated while rotating on a microwave turntable, or manufactured goods carried on conveyor systems).

As used herein, motion of a load carrier includes, for example, rotational or periodic motion of a load carrier. For example, a rotational load carrier itself may rotate, or the motion of a rotational load carrier may follow a periodic path (e.g., a conveyor belt following a loop path, or a load carrier that oscillates), and rotational motion can include elliptical (e.g., including circular) or non-elliptical periodic motion. In particular embodiments, rotational motion can be represented by a function θ(t), where θ describes the periodic aspects (for example, but not limited to, circular motion) of the load carrier's motion and t represents time. Motion of a load carrier also includes, in particular embodiments, motion of at least a portion of the load carrier along one or more predetermined trajectories. For example, a load carrier may carry an object along a predetermined path. In particular embodiments, sequential runs of one or more load carriers over a particular predetermined path may be parameterized by an angle between 0 radians (the start of the predetermined path) and 2*pi (the end of the predetermined path), and N completed runs along a particular predetermined path may be treated as N rotations from 0 to 2*pi. However, particular embodiments may not use any such parameterization to describe carrier motion.

Particular embodiments of this disclosure estimate in real time the state and/or position of load-carrying components (the “carrier state”) based on observations of the load. Particular embodiments formulate the problem of estimating the time-varying position (or time-varying state, more generally) of a load carrier (such as a microwave turntable, conveyor belt, rotisserie spindle, etc.) as a problem of parameter estimation from observations. As explained herein, the observations may be a set of measurements that include thermal or optical images, among other things.

A carrier state of a system apparatus may be defined by a pair of vectors:

$$τ = ( {τ}^{i} , i = 1 , ... , {n}_{τ} ) , θ = ( {θ}^{i} , i = 1 , ... , {n}_{θ} ) \qquad ( 1 )$$

where τ represents the input parameters and θ represents the state variables. For example, for a microwave turntable both τ and θ are scalars, (n_{τ}=n_{θ}=1), τ represents time, and θ=θ(τ) is the rotation angle of the turntable at time τ. In other examples, θ=θ(τ) may represent translation motion, e.g., along a predetermined path (in other words, θ represents the state variables generally, and is not limited to references to angles). Although the input parameter may be a scalar time in many applications, the approach still holds if τ and θ are arbitrary-length vectors. Associated with each value of the input parameter (e.g., time) is a vector of measurable attributes (the “data”):

$$d = d ( τ ) = d ( τ , θ ( τ ) ) = ( {d}^{i} ( τ , θ ( τ ) ) , i = 1 , ... , N ) \qquad ( 2 )$$

that represent observable features of the load, carrier, an other components of the apparatus. In general, the input parameter τ may encode more than a temporal marker, and the data samples (2) are indexed sequentially. For each known value of the input parameter τ the data vector (2) depends on an unknown value of the state variable θ=θ(x) for that input parameter. Such dependence may be referred to as an observation model. For example, d may consist of visual images and/or thermometric measurements:

$$d = d ( τ , θ ( τ ) ) = ( I ( τ , x , y , θ ( τ ) ) , T ( τ , x , y , θ ( τ ) ) ) , \qquad ( 3 )$$

where I(τ,x,y,θ(τ))≡I(x,y,θ(τ)) is an image of the load and carrier obtained (e.g., using an RGB camera) when the carrier state (e.g., turntable rotation angle) is θ at time τ, and T(τ, x,y,θ(τ)) is a temperature map (e.g., obtained using an infrared camera), and (x,y)∈D_{I} or (x,y)∈D_{T}, where D_{I}, D_{T} are the fields of view of the RGB and infrared cameras, respectively. While certain examples herein use observable data that are two-dimensional optical or thermal images, this disclosure contemplates that observable data may have different dimensions or be of a different type. The objective is to calculate a statistic of the load or apparatus given by an expression:

$$S = S ( τ , θ ( τ ) ) = F [ τ , θ ( τ ) , d ( τ , θ ( τ ) ) ] \qquad ( 4 )$$

for any values of the input parameter τ for which observations (2) are available. In the example of a microwave turntable example, S(τ,θ(τ)) might represent the mean temperature of food at time τ and turntable angle θ(τ).

Since θ is presumed to be unknown or uncertain, the evaluation of (4) involves explicit or implicit estimation of θ(τ) from Nₛₐₘₚ observations of the measurable data (2). Given known values of the input parameter τᵢ and the corresponding data observations dᵢ, embodiments estimate the conditional probabilities of the state variable for each sample,

$${θ}_{i} ∼ p ( θ \vert {d}_{i} , {τ}_{i} ) , \qquad ( 5 )$$

as well as the maximum a posteriori (MAP) estimate and/or the conditional expectation of the state variable:

$${θ}_{i}^{*} = arg max [ p ( θ \vert {d}_{i} , {τ}_{i} ) ] , \qquad ( 6 )$$

$${\overline{θ}}_{ι} = {𝔼}_{p ( θ \vert {d}_{i} , {τ}_{i} )} [ θ ] . \qquad ( 7 )$$

Once (5-7) are known, embodiments estimate the probability distribution, MAP estimate, and/or the expected value of (4):

$${S}_{i} ( θ ) = F [ {τ}_{i} , θ , {d}_{i} ] ∼ p ( S = F [ {τ}_{i} , θ , {d}_{i} ] \vert {d}_{i} , {τ}_{i} ) = p ( θ \vert {d}_{i} , {τ}_{i} ) , \qquad ( 8 )$$

$${S}_{i}^{*} = F [ {τ}_{i} , {θ}_{i}^{*} , {d}_{i} ] , \qquad ( 9 )$$

$${\overline{S}}_{ι} = {𝔼}_{p ( θ \vert {d}_{i} , {τ}_{i} )} [ F [ {τ}_{i} , θ , {d}_{i} ] ] . \qquad ( 10 )$$

In the discussion above, i=1, . . . , Nₛₐₘₚ and “x˜p( )” indicates that a variable x is drawn from the probability distribution p( ). The posterior probability (5) can be estimated using Bayes' rule:

$$p ( θ \vert {d}_{i} , {τ}_{i} ) = \frac{p ( {d}_{i} \vert θ , {τ}_{i} ) p ( θ , {τ}_{i} )}{p ( {d}_{i} , {τ}_{i} )} ∼ p ( {d}_{i} \vert θ , {τ}_{i} ) p ( θ , {τ}_{i} ) , \qquad ( 11 )$$

where the denominator is a normalizing factor, and p(θ, τᵢ) is a prior probability of the state variable for τ=τᵢ. The probability p(θ, τᵢ) describes a “state prior”, “state model”, or “state evolution model” while p(dᵢ|θ, τᵢ) provides an “observation model”.

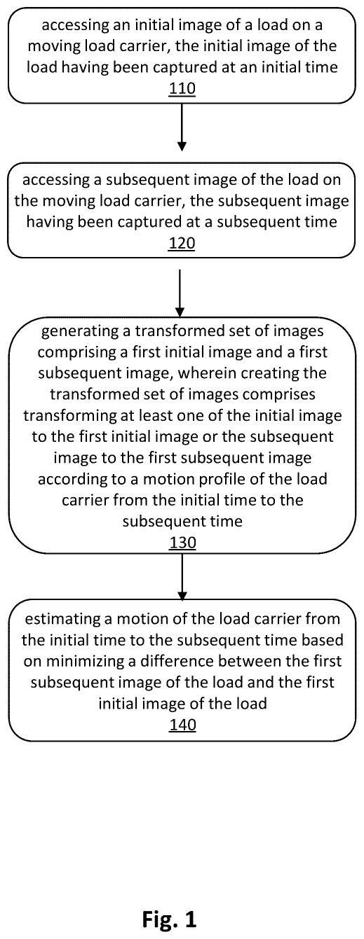

FIG. 1 illustrates an example method for estimating the motion of a load carrier that utilizes the approach described in equation 5. In the example method of FIG. 1 the measurable data are images (e.g., RGB images, thermal images, etc.), although this disclosure contemplates that any suitable measurable may be used to estimate the motion of the load carrier.

Step 110 of the example method of FIG. 1 includes accessing an initial image of a load on a moving load carrier, the initial image of the load having been captured at an initial time. For example, the initial image may be an RGB image or a thermal image (or a combination of such images) of a food item on a microwave turntable taken at an initial time, e.g., before heating of the food item has occurred or when heating has first started. Step 120 of the example method of FIG. 1 includes accessing a subsequent image of the load on the moving load carrier, the subsequent image having been captured at a subsequent time. For example, the subsequent image may be of the same type (e.g., RGB image or thermal image) as the initial image and is captured at a later time.

Step 130 of the example method of FIG. 1 includes generating a transformed image set that includes a first initial image and a first subsequent image. Step 130 is performed by transforming at least one of (1) the initial image to the first initial image or (2) the subsequent image to the first subsequent image according to a motion profile of the load carrier from the initial time to the subsequent time. For example, the motion profile of the load carrier may be defined by a rotation of the load captured in the initial image and the subsequent image (e.g., the load may rotate as a result of rotation of the load carrier, such as rotation of a turntable in a microwave). In this example, for instance, the transformation may be a rotation of either or both of the initial image and the subsequent, image, e.g., as discussed in connection with equation 14, below. As another example, the motion profile of the load carrier may be defined by a translation of the load captured in the initial image and the subsequent image (e.g., the load may translate as a result of rotation of the load carrier, such translation of a load along a conveyor belt). Either or both of the initial image and the subsequent image may be transformed in step 130; e.g., the first initial image may be the initial image accessed in step 110 and the first subsequent image may be obtained by transforming the subsequent image accessed in step 120, or the first initial image may be obtained by transforming the initial image accessed in step 110 and the first subsequent image may be the subsequent image accessed in step 120, or the first initial image may be obtained by transforming the initial image accessed in step 110 and the first subsequent image may be obtained by transforming the subsequent image accessed in step 120 (e.g., a relative rotation of 90 degrees may be represented by rotation of one image by 90 degrees, the other image by −90 degrees, or each image by 45 and −45 degrees, respectively; similar analysis applies to relative translations).

Step 140 of the example method of FIG. 1 includes estimating a motion of the load carrier from the initial time to the subsequent time based on minimizing a difference between the first subsequent image of the load and the first initial image of the load. The estimated movement may be expressed in any suitable units (e.g., degrees, radians, number of rotations, feet, etc.). In step 140, estimating the motion of the load may be achieved by estimating the motion of the load relative to a fixed point (e.g., rotation relative to the microwave housing) or may be achieved by estimating the relative motion of the load to the imaging apparatus that captured the initial and subsequent images. Steps 130 and 140 may together include transformation (e.g., rotating) either or both of the initial image and the subsequent image to minimize the difference between those images.

In particular embodiments, step 140 of the example method of FIG. 1 includes solving the MAP estimation problem (equations 6 and 11) with a prior p(θ, τᵢ) based on some assumption of how the state variable θ depends on τ and based on the application-specific conditional probability of the observed data given θ and τᵢ, that is: p(dᵢ|θ, τᵢ). Starting with image-based measurement data in (3), if the dependence of an RGB or thermal image on θ is given by a function I(x,y,θ), and the image obtained at time τ=τᵢ is Iᵢ(x,y), then assuming an uncorrelated Gaussian measurement noise with variance σ_{I}² results in:

$$p ( {d}_{i} \vert θ , {τ}_{i} ) = p ( {I}_{i} \vert θ , {τ}_{i} ) ∼ exp [ - \frac{{‖ I ( x , y , θ ) - {I}_{i} ( x , y ) ‖}_{2}^{2}}{2 {σ}_{I}^{2}} ] , \qquad ( 12 )$$

and (6) becomes the nonlinear optimization problem:

$${θ}_{i}^{*} = {arg min}_{θ} [ \frac{{‖ I ( x , y , θ ) - {I}_{i} ( x , y ) ‖}_{2}^{2}}{2 {σ}_{I}^{2}} - log p ( θ , {τ}_{i} ) ] , \qquad ( 13 )$$

where log p(θ, τᵢ) is a state-variable likelihood prior that, for example, penalizes unexpected values of θᵢ. In particular embodiment, step 140 of the example method of FIG. 1 estimates motion, such as rotation, using equation 13, i.e., based on both (1) the difference between the first subsequent image of the load and the first initial image of the load and (2) a likelihood distribution of the motion of the load carrier at the subsequent time. In particular embodiments, step 140 of the example method of FIG. 1 estimates motion of a load carrier based only on the difference between the subsequent image of the load and a transformation (e.g., rotation) applied to the initial image of the load, which can simplify the resulting estimate.

In an example in which the load carrier is a microwave turntable, then a subsequent image after some rotation can be represented by the following transformation:

$$I ( x , y , θ ) = {R}_{θ} [ I ( x , y , 0 ) ] + {ϵ}_{1} + {ϵ}_{2} , \qquad ( 14 )$$

where θ is a rotation angle of the turntable, R_{θ} is the planar (image) rotation operator, and ϵ₁, ϵ₂ represent random and non-random noise. Sensor noise may be an example of random noise, while specular reflections (e.g., bright spots that consistently appear across image) are examples of non-random noise. While the example of equation 14 represents an image transformation of I(x,y,0) as a rotation of the image, this disclosure contemplates that the motion of a carrier may be represented, for any particular image of the carrier, as other transformations of the image (e.g., by a translation of an image of a load moving along a conveyor belt carrier, or by a combination of a rotation and a translation of an image, etc.).

In particular embodiments, a likelihood prior may be a constant mean rate of rotation:

$$log p ( θ , {τ}_{i} ) = const - \frac{{( θ - {θ}_{i - 1} - \overline{ω} ( {τ}_{i} - {τ}_{i - 1} ) )}^{2}}{2 {σ}_{{θ}_{i - 1}}^{2}} , \qquad ( 15 )$$

$$\overline{ω} = 𝔼 [ {ω}_{i} ] ,$$

$${ω}_{i} = \frac{{θ}_{i} - {θ}_{i - 1}}{{τ}_{i} - {τ}_{i - 1}} ,$$

where ωᵢ and ω̅ are the instantaneous and mean rotation rate, respectively, and σ_{θ}_{_{i−1}}² is the angle variance estimated at the previous time step. For example, the initial constant mean rate of rotation may be a specified rotation rate, e.g., as provided by the manufacturer. As described below, other likelihood priors may be used to estimate the rotation of a load carrier. While the example of FIG. 15 describes motion of a rotating load carrier in the context of rotation, similar formulations of the likelihood prior may be used for translations, with suitable change of variables from angular coordinates to, e.g., Cartesian coordinates (e.g., instantaneous and mean rotation rate become instantaneous and mean velocity, etc.).

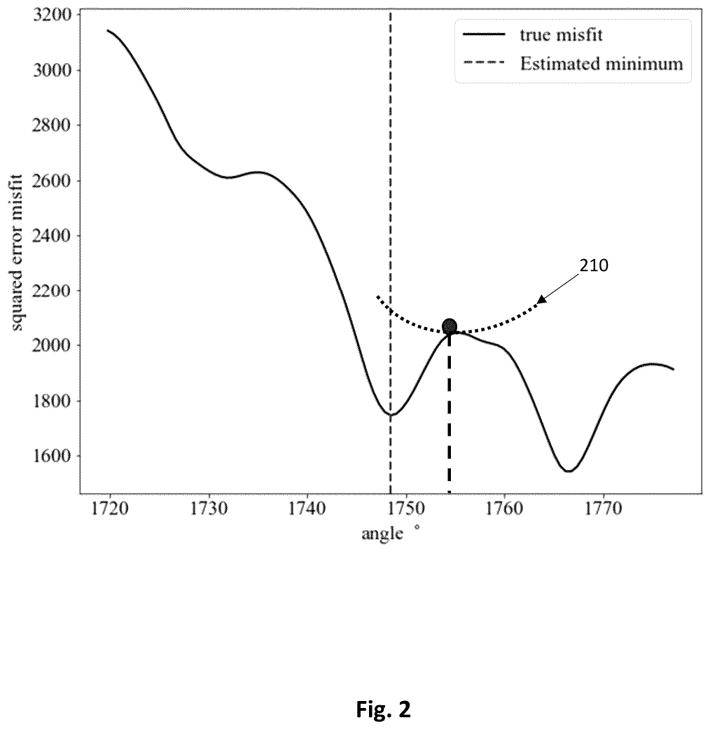

With prior (15), equation (13) becomes:

$${θ}_{i}^{*} = arg min [ \frac{{‖ M ( x , y ) ( {R}_{θ} I ( x , y , 0 ) - {I}_{i} ( x , y ) ) ‖}_{2}^{2}}{2 {σ}_{I}^{2}} + \frac{{( θ - {θ}_{i - 1} - \overline{ω} ( {τ}_{i} - {τ}_{i - 1} ) )}^{2}}{2 {σ}_{{θ}_{i - 1}}^{2}} ] \qquad ( 16 )$$

where M is an arbitrary image-processing operator (for example, but without limitation, a masking operator). Solving equation (16) and the subsequent estimation of the state variable variance σ_{θ}² is an example of a Bayesian filter. By linearizing R_{θ}I(x,y,0)−Iᵢ(x,y) at the prior expectation \tilde{θ}= [symbol] _{p(θ,τ}_{ᵢ}₎ [θ], equation (16) becomes equivalent to an Extended Kalman Filter (EKF). FIG. 2 illustrates an example graph of the objective function (16) at a single time in the example of cooking a food item on a microwave turntable. The best estimate for the amount of rotation is the angle that minimizes the difference, or misfit, between images while taking into account the prior; in the example of FIG. 2, this best estimate is the lowest point on the graphed curve. For the highly nonlinear objective function (16), even a small error in the prior angle expectation [symbol] _{p(θ,τ}_{ᵢ}₎ [θ] due to the oscillatory true instantaneous rotation rate ωᵢ may result in the solution to (16) converging to a wrong local minimum (e.g., to a local minimum that is not the global minimum). Approximation of (16) with a quadratic objective function as in EKF (e.g., quadratic 210 in the example of FIG. 2) may likewise result in a wrong minimum if the prior angle expectation [symbol] _{p(θ,τ}_{ᵢ}₎ [θ] is sufficiently inaccurate.

In particular embodiments, equation (16) may be solved using numerical methods of nonlinear optimization such as (for example) nonlinear Conjugate Gradients, Newton, quasi-Newton, and Gauss-Newton methods. Such methods may require multiple iterations to converge. For example, particular embodiments may use numerically computed first and second derivatives of the objective function with respect to the state variable θ in a full Newton implementation.

In practice, the instantaneous rotation rate of a load carrier is not constant but rather varies, potentially for many different reasons (e.g., noise, bias, load-dependent characteristics, etc.). Moreover, as illustrated in FIG. 2, an objective function used to estimate θᵢ may have more than one local minimum. If the probability prior (15) yields an expected value of θ that is too far from the global minimum, a quadratic optimization step may yield the wrong estimate for θ. Particular embodiments address these challenges by adopting improved estimates of the likelihood prior for a given load carrier.

In particular embodiments, suboptimal priors (which may be equivalent to poor initial approximations or inaccurate linearization points for the objective function (16)) can be remedied by reducing the average sampling rate [symbol] [τᵢ−τᵢ₋₁]. For example, rapid updates in the estimate for the turntable angle prevent large errors from accumulating, even if the rotation rate is not truly constant. For instance, a sampling rate of below 1 second or 0.5 second may allow a solution to (16) by a Newton solver to converge within acceptable time and avoid wrong local minima. However, such rapid re-calculation of the turntable angle requires a large amount of computing resources, which improved estimates of the likelihood prior can avoid.

As an example of using improved priors to inform the initial estimate of the state variable θ, particular embodiments treat the set of all permissible carrier states (e.g., the states defining the rotational dynamics of the load carrier) as a stochastic process that in the most general case is defined by a joint probability density function for arbitrary multiple states (an instance of a “state evolution model”):

$$p ( {θ}_{{i}_{1}} , {θ}_{{i}_{2}} , … , {θ}_{{i}_{K}} ; {τ}_{{i}_{1}} , {τ}_{{i}_{2}} , … , {τ}_{{i}_{K}} ) \qquad ( 17 )$$

where the joint probability distribution (17) can be, for example, a multivariate Gaussian distribution, with the state variables forming a Gaussian Random Field. Equation 17 may also be representing as p(θᵢ_{₁},θᵢ_{₂}, . . . , θᵢ_{_{K}}; τᵢ_{₁}, τᵢ_{₂}, . . . , τᵢ_{_{K}}; λ), which is parameterized by a vector of unknown latent parameters λ. For example, as explained below in the context of a microwave turntable, the vector λ includes parameters in generating functions of πₖ, tₖ, and rₖ, which represent, respectively, a quasi-period rotational term, a non-random and non-periodic trend in the rotation rate, and random noise in the rotation rate as in equation (22) below.

Using time as the input parameter τ can consider causal processes, with the state prior now defined by a conditional probability of a state given earlier states. More specifically,

$$p ( θ \vert {d}_{i} , {θ}_{i - 1} , … , {θ}_{1} ; {τ}_{i} ) = \frac{p ( {d}_{i} \vert θ ; {τ}_{i} ) p ( θ , {θ}_{i - 1} , … , {θ}_{1} ; {τ}_{i} )}{p ( {d}_{i} , {τ}_{i} )} ∼ p ( {d}_{i} \vert θ , {τ}_{i} ) p ( {θ}_{i} = θ \vert {θ}_{i - 1} , … , {θ}_{1} ; {τ}_{i} ) p ( {θ}_{i - 1} , … , {θ}_{1} ; {τ}_{i} ) , \qquad ( 18 )$$

which assumes that current observations depend only the current carrier state, p(dᵢ|θ, θᵢ₋₁, . . . , θ₁; τᵢ)=p(dᵢ|θ; τᵢ). In essence, Equation (18) extends the conditional probability analysis to a series of prior observations of the carrier angle, potentially informed by a physical model of the carrier rotation.

Using the state evolution model and assuming that the acceleration is white noise, Equation (13) becomes

$${θ}_{i}^{*} = arg min [ \frac{{‖ I ( x , y , θ ) - {I}_{i} ( x , y ) ‖}_{2}^{2}}{2 {σ}_{I}^{2}} - log p ( {θ}_{i} = θ \vert {θ}_{i - 1} , … , {θ}_{1} ; {τ}_{i} ) ] , \qquad ( 19 )$$

$$with$$

$$log p ( {θ}_{i} = θ \vert {θ}_{i - 1} , … , {θ}_{1} ) = const - \frac{{( θ - {θ}_{i - 1} - {ω}_{i} ( {τ}_{i} - {τ}_{i - 1} ) )}^{2}}{2 [ {σ}_{{θ}_{i - 1}}^{2} + {{σ}_{a}^{2} ( {τ}_{i} - {τ}_{i - 1} )}^{2} ]} ,$$

$${ω}_{i} = \frac{{θ}_{i - 1} - {θ}_{i - 2}}{{τ}_{i - 1} - {τ}_{i - 2}} + δ {ω}_{i} , {δω}_{i} ∼ N ( 0 ; {σ}_{a}^{2} ) , \qquad ( 20 )$$

where σₐ² is the estimated variance of random accelerations. The distribution (20) describes a non-stationary Brownian motion. Zero angular acceleration corresponds to constant rotation rate. Equation (20) is an updated version of equation (15) that includes an example of an improved state-variable likelihood prior.

Using the improved likelihood prior, particular embodiments determine the statistics of the carrier motion as the process evolves by calculating the conditional probability:

$$p ( {θ}_{j} = θ \vert {θ}_{j - 1} , … , {θ}_{1} ; {τ}_{i} ) \qquad ( 21 )$$

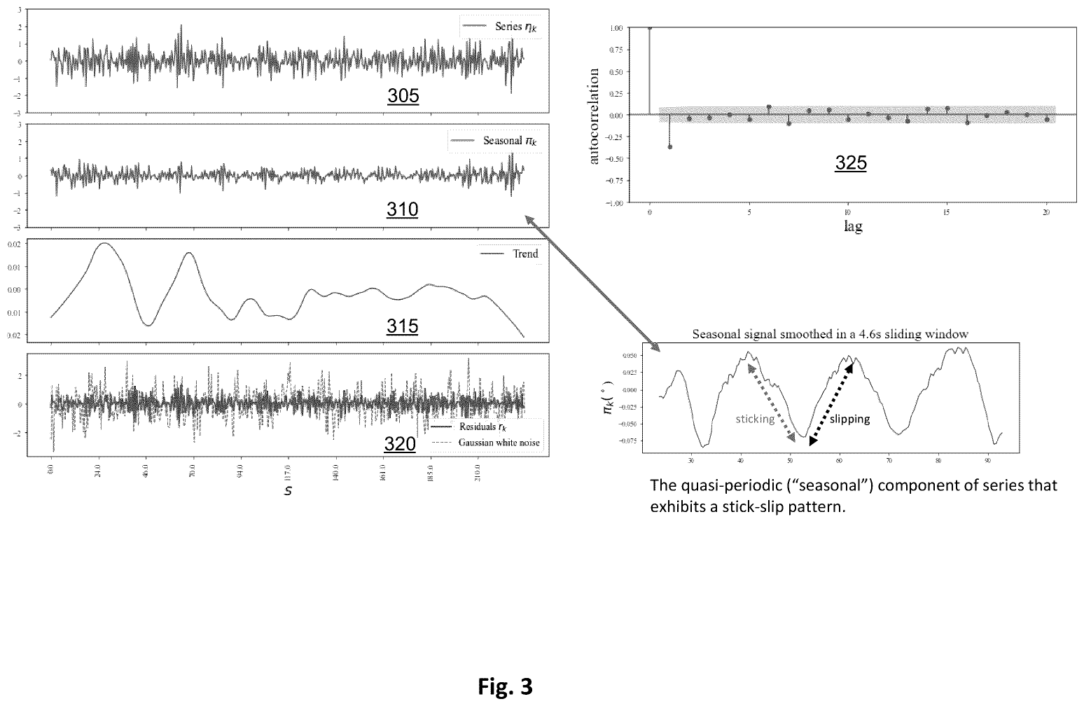

for arbitrary values of j. After sufficient data is obtained, then equation (21) can be numerically evaluated, and equation (19) can be solved for subsequent states. This is equivalent to applying a Bayesian Filter. Returning to the microwave turntable example, graph 305 of FIG. 3 plots an example deviation ηₖ in the rotation rate (compared to constant rotation) as parameterized according to:

$${η}_{k} = \frac{{θ}_{k} - {θ}_{k - 1}}{{τ}_{k} - {τ}_{k - 1}} - \overline{ω} = {π}_{k} + {r}_{k} + {r}_{k} , k = 2 , … , {N}_{samp} , \qquad ( 22 )$$

where θₖ are solutions of (16) and ω̅ is the average rotational velocity. Graphs 310, 315, and 320 display the components of a decomposition of the series into a seasonal (quasi-periodic) signal πₖ, a non-random and non-periodic trend tₖ, and the residuals rₖ, respectively.

In the example of FIG. 3, the autocorrelation function for rₖ (illustrated in graph 325) has only one significant lag, indicating that rₖ is a moving average process of lag 1, MA(1):

$${r}_{k} = {ϵ}_{k} + {α}_{1} {ϵ}_{k - 1} , k = 2 , … , {N}_{samp} , {ϵ}_{k} ∼ N ( 0 ; {σ}_{ϵ}^{2} ) \qquad ( 23 )$$

and process ϵₖ is white. More generally, rₖ may indicate an autoregressive (AR) or autoregressive moving average (ARMA) process:

$${r}_{k} = {\sum }_{j = 1}^{p} {β}_{j} {r}_{k - j} + {\sum }_{j = 1}^{q} {α}_{j} {ϵ}_{k - j} + {ϵ}_{k} , \qquad ( 24 )$$

$$k = max ( p , q ) + 1 , … , {N}_{samp} , {ϵ}_{k} ∼ N ( 0 ; {σ}_{ϵ}^{2} )$$

where ϵₖ is white and the stochastic process is ARMA(p,q). The seasonal component and trend are typically deterministic signals and may be represented as a linear combination of a constant bias b₀, linear function b₁τ and signals that make up a “basis” or “dictionary”,

$${π}_{k} + {t}_{k} = {b}_{0} + {b}_{1} {τ}_{k} + {\sum }_{j = 1}^{d} {γ}_{j} {X}_{k}^{j} , \qquad ( 25 )$$

where {Xₖ^{j}}, j=1, . . . , d is such a dictionary of signals. For example, in the example of FIG. 3, decomposition (22) features a weak quasi-periodic component and a weak trend. The seasonal component πₖ visualized in FIG. 3 reveals periods of increasing and decreasing rotational velocity that could be indicative of a “stick-slip” behavior of the carrier surface or caused by an uncompensated shift of the camera from the physical center of rotation. Piecewise polynomial or trigonometric functions of time are examples of signal “dictionaries.” Particular embodiments fit the representations (24) and (25) to series (22) (i.e., determine values of the coefficients α_{1, . . . q}, β_{1, . . . , p}, b_{0,1}, γ_{1, . . . , d}) by converting equation (22) into, for example, a least-squares regression problem:

$${α}_{1 , …q} , {β}_{1 , … , p} , {b}_{0 , 1} , {γ}_{1 , … , d} , {ω}^{*} = arg min \{ {𝔼}_{{ϵ}_{1} , … , {ϵ}_{{N}_{samp}}} [ {\sum }_{k = max ( p , q ) + 1}^{{N}_{samp}} {{σ}_{{η}_{k}}^{- 2} ( \frac{{θ}_{k} - {θ}_{k - 1}}{{τ}_{k} - {τ}_{k - 1}} - \overline{ω} - {π}_{k} - {t}_{k} - {r}_{k} )}^{2} ] \} , \qquad ( 26 )$$

where the expectation is with respect to the Gaussian white process ϵₖ. Once the coefficients have been determined, the conditional probability (21) can be explicitly calculated as:

$$log p ( {θ}_{j} = θ \vert {θ}_{j - 1} ; {τ}_{i} ) = const - \frac{{( θ - {θ}_{j - 1} - \{ \overline{ω} + {π}_{j} + {t}_{j} + {r}_{j} \} ( {τ}_{j} - {τ}_{j - 1} ) )}^{2}}{2 [ {σ}_{{θ}_{j - 1}}^{2} + {( {τ}_{j} - {τ}_{j - 1} )}^{2} {σ}_{{r}_{j}}^{2} ]} , \qquad ( 27 )$$

where rⱼ, πⱼ, tⱼ are forecast according to (24) and (25), σᵣ_{ₖ}² is the variance of (24) (independent of k for a stationary process), and variances of the estimated carrier state σ_{θ}_{_{j−1}}² are obtained from the solution of (19). Equations (22) through (26) provide one example of a parameterized stochastic process for the carrier motion, with the end result being that Eq. (27) is used for the estimate of θᵢ* in Eq. (19). In this example, unknown parameters within the stochastic model are estimated in tandem with the estimation of θᵢ*. The result is an estimate of the carrier motion that does not require the rapid updates described above, can be calculated in real time or near real time, and is robust to noise or numerical error. As described above, the state estimation and state uncertainty estimation in this example uses a combination of real-time observations and the postulated stochastic process of state evolution.

Equation (24) illustrates a discrete ARMA process for performing state variable estimation with some exogenous variables Xₖ^{j} in (25), and the observations are camera images. This disclosure contemplates other approaches, including a range of scenarios such as when state evolution is a numerical discretization of a continuous physical law or a stochastic differential equation; state evolution is a continuous auto-regressive moving-average process; state evolution is governed by a Gaussian process with known or inaccurate input parameters; the observation model is a Gaussian process; the observation model is non-Gaussian; or one or both of state evolution and observation models is described by a probabilistic graphical network, such as a neural network.

While the transformation discussed above in connection with equation (14) uses rotation as an example, the general transformation operator R_{θ}[ ] referenced in equation (14) above and elsewhere generally applies to any kind of carrier motion described herein. For example, let I(x,y,0) be the initial image and I(x,y,0) the transformed (e.g., rotated) image. For convenience we introduce vector notation ζ=(x,y), ζ′=(x′,y′), and define the action of a motion operator R_{θ}[ ] on the initial image as:

$$I ( x , y , θ ) = I ( ζ , θ ) = {R}_{θ} [ I ( \cdot , 0 ) ] ( ζ ) := I ( {ζ}^{′} , 0 ) = I ( {x}^{′} , {y}^{′} , 0 ) , where \qquad ( M - 1 )$$

$$ζ = {A}_{θ} {ζ}^{′} ,$$

and A_{θ}: R²→R² is a parameterized planar map (not necessarily linear). For example,

$${A}_{θ} {ζ}^{′} = [ \begin{matrix}cos θ & - sin θ \\ sin θ & cos θ\end{matrix} ] {ζ}^{′} \qquad ( M - 2 )$$

may describe carrier rotation, and

$${A}_{{θ}_{1} , {θ}_{2}} {ζ}^{′} = [ \begin{matrix}cos {θ}_{1} & - sin {θ}_{1} \\ sin {θ}_{1} & cos {θ}_{1}\end{matrix} ] {ζ}^{′} + [ \begin{matrix}{f}_{1} ( {θ}_{2} ) \\ {f}_{2} ( {θ}_{2} )\end{matrix} ] \qquad ( M - 3 )$$

may describe rotation parameterized by a state variable θ₁, and coordinate translation described by two arbitrary application-specific functions (e.g., conveyor trajectory coordinates) that may be given analytically or algorithmically and parameterized by a state variable θ₂. Note that θ₂ may itself be a “multi-parameter”—e.g., a vector parameter. Temporal evolution of the state variables in equations (M-2) and (M-3) can be given in a closed functional form or algorithmically:

$${θ}_{i} = {θ}_{i} ( t , p ) , \qquad ( M - 4 )$$

where t is time and p stands for (a vector of) system parameters, such as rotation velocity v in θ₁=vt or linear velocity scaler c and offset c in θ₂=ct+b, but can be any parameters required for evaluating equations (M-1 through M-4) for arbitrary time t as part of likelihood maximization in equations (13,16,19).

Although this discussion formulates state variable estimation using matching of two-dimensional images in (13) and elsewhere, the motion may occur in three dimensions. For example:

$$I ( x , y , θ ) = I ( ζ , θ ) = {I}_{3} ( {ζ}^{″} , 0 ) = {I}_{3} ( {x}^{′} , {y}^{′} , {z}^{′} , 0 ) , where \qquad ( M - 5 )$$

$${ζ}^{″} = ( {x}^{′} , {y}^{′} , {z}^{′} ) , ζ = {A}_{θ} {ζ}^{″} ,$$

I₃(x′,y′,z′,0) is a 3D “image” of the load at the initial time, and the operator A_{θ} R³→R² is given by, for example:

$${A}_{θ} {ζ}^{″} = [ \begin{matrix}1 & 0 & 0 \\ 0 & 1 & 0\end{matrix} ] [ \begin{matrix}cos ϕ & 0 & sin ϕ \\ 0 & 1 & 0 \\ - sin ϕ & 0 & cos ϕ\end{matrix} ] \{ [ \begin{matrix}cos θ & - sin θ & 0 \\ sin θ & cos θ & 0 \\ 0 & 0 & 1\end{matrix} ] {ζ}^{″} + [ \begin{matrix}{f}_{1} ( ψ ) \\ {f}_{2} ( ψ ) \\ {f}_{3} ( ψ )\end{matrix} ] \} \qquad ( M - 6 )$$

In (M-6), all or some of the state variables ϕ, θ, ψ may be functions of time as in (M-4) above, or constant hyper parameters. The transformation (M-6) may describe a turntable rotation around the third axis (the innermost 3×3 matrix) followed by an optional translation (e.g., turntable rising and lowering), followed by tilting from the third axis by an angle ϕ (e.g., to simulate an observation camera mounted off center), and finally projection onto the camera image plane. Note that a non-zero tilt ϕ may mean temporary occlusion of some portions of the 3D “image” I₃(x′,y′,z′,0) (e.g., sides of elevated loads may not be fully visible at all rotation angles).

While this disclosure provides specific examples of transforms, the techniques described herein apply to any ansatz transforms A_{θ} parameterized by “state variables” that allow numerical likelihood evaluation and maximization as in equations (13,16,19) and elsewhere in this disclosure.

This disclosure contemplates that all or some portions of images may be used as the measurable data. For example, a portion of an image (e.g., a segmentation mask) identifying a load separately from the background may be identified from an image. The transformation (e.g., rotation and/or translation) of the segmentation mask is then subsequently calculated. In a rotational example, defining the mask as L(x,y,θ(τ)) and the initial mask as L(x,y,0) results in:

$$L ( x , y , θ ) = {R}_{θ} [ L ( x , y , 0 ) ] , \qquad ( 28 )$$

where R_{θ} is a computed rotational transform by angle θ. The updated (transformed) segmentation mask can then be used to determine other metrics. For example, in the microwave context, one goal may be to estimate the 5^{th} and 95^{th} percentiles of the food temperature, where the food (i.e., the load in this example) is identified by the mask. The desired statistics (4) are then:

$$S ( θ ( τ ) ) = {Percentile}_{5 , \% 95 \%} \{ z : z = T ( τ , x , y , θ ( τ ) ) , ( x , y ) ∈ {D}_{T} , L ( x , y , θ ) = 1 \} , \qquad ( 29 )$$

Other statics of the load, including thermal statics, may likewise be determined based on the updated segmentation mask, including but not limited to a temperature distribution of the load, a mean temperature of the load, a median temperature of the load, etc. As this example illustrates, instead of using dynamic masking, accurate segmentation can be obtained using a less computationally demanding approach by calculating a static load mask once, then transforming the mask to its current position at a given time by accurately estimating the transformation (rotation and/or translation) it underwent up to that time due to motion by the rotating load carrier. Particular embodiments may use the estimated carrier state to correct measurements (such as thermal images) for carrier motion that has occurred since the initial state; calculate the desired statistics after applying a static load mask to the motion-compensated measurements; or to use the estimated carrier state to update in real time a dynamic load mask.

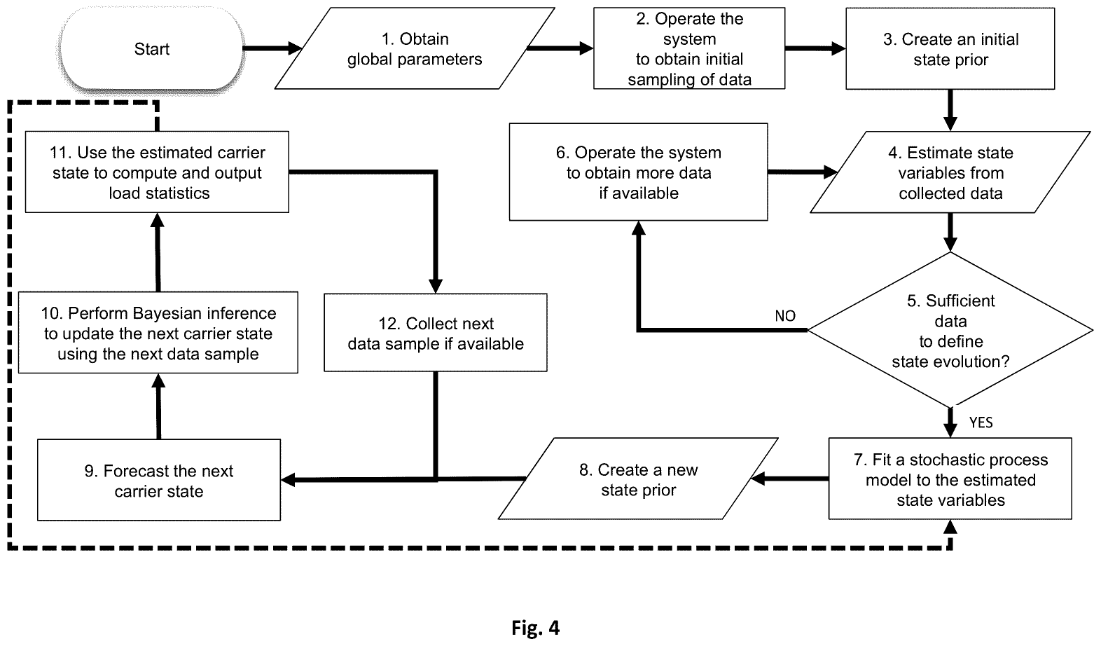

FIG. 4 illustrates a specific example implementation of the example method of FIG. 1 in the context of a rotating load carrier. The implementation of FIG. 4 includes many additional features described herein, although those features may not be present in any particular embodiment of FIG. 1. The implementation of FIG. 4 describes a particular process that can occur for each distinct episode in which statistics of a load carrier are estimated (e.g., each time a microwave is used to heat a food item, etc.). More broadly, the example method of FIG. 1 and/or the example implementation of FIG. 4 may be performed each time a user places food in a microwave and heats the food. In particular embodiments, either or both processes may occur under particular operational settings (e.g., when heating is set to occur for longer than a threshold time, when a particular heating function (e.g., defrosting) is selected, etc.). While the discussion related to FIG. 4 uses rotational motion as an example, the steps of FIG. 4 may be used to estimate any kind of carrier motion, as described herein.

Step 1 of the example implementation shown in FIG. 4 includes obtaining global parameters, if any, relevant for estimating the rotation rate of a carrier or subsequent statistics. As illustrated in the examples above, an estimated rotation rate may be a constant rotation rate or may be a rotation rate that varies as a function of time (e.g., the estimated rotation rate may be an estimate of the rotation rate at a particular point in time or an estimate of a variable rotation rate over time). For example, global parameters may be a measurement of the fraction of the carrier covered by a load. Step 2 of the example implementation shown in FIG. 4 includes operating the system to obtain an initial sampling of data. This initial sampling may be a single data point at an initial time (e.g., d₁ at a time τ₁) or may be an initial set of data samples. For instance, in the example of a microwave oven, the initial sampling may be an initial image or images (e.g., RGB, thermal, etc.) of the interior of the microwave. The amount of data may depend on the implementation and desired model accuracy; for example, a few frames of data (e.g., captured at 30 frames per second or 60 frames per second, etc.) may be sufficient to complete step 2. In particular embodiments, 10-20 seconds of data may be used to complete step 2. Step 3 of the example implementation shown in FIG. 3 involves creating an initial state prior to use to initially estimate the rotation rate. For example, the initial state prior may be a constant rotation rate, e.g., as provided by a manufacturer. In particular embodiments, the initial state prior may be statistics determined in a previous run of FIG. 4 for that apparatus, e.g., an average rotation rate determined for that apparatus during a previous usage of that apparatus. As the system operates, the system continues to collect data samples at particular points in time.

Step 4 of the example implementation shown in FIG. 4 includes estimating state variables from the collected data. For example, as described above, the system may estimate an amount of rotation (along with other statistics, in particular embodiments) at a given point in time based on minimizing a difference between an image taken at that point in time and an initial image taken at a previous time, with at least one of the images transformed as described above. In particular embodiments, the state variables may also take into account the initial state prior, e.g., as shown in equation 13. Meanwhile, the system continues to periodically collect data samples.

At step 5, the system determines whether sufficient data has been collected to define the state evolution. “Sufficient data” has been collected when the system has enough data points to estimate the parameters of a specific probability distribution (21). For example, the system has enough data points to estimate a probability distribution such as (27) when it can solve the corresponding parameter estimation regression problem (26). If enough data has not been collected, then the system continues to collect data and continues to use step 4 to estimate state variables. If enough data has been collected, then the implementation proceeds to step 7, which begins an improved estimation process for the state variables. As illustrated in the example implementation of FIG. 4, a system may initially estimate state variables using initial data and inputs (e.g., an initial state prior), and may subsequently switch to an improved process for estimating state variables when enough data has been collected to make that estimation.

Step 7 of the example implementation of FIG. 4 includes fitting a stochastic process model to the estimated state variables. In particular embodiments, step 7 may include fitting the latent parameters λ* to estimated states θᵢ* by solving the following equation:

$${λ}^{*} = arg max [ p ( {θ}_{1}^{*} , {θ}_{2}^{*} , ... , {θ}_{{N}_{samp}}^{*} ; {τ}_{1} , {τ}_{2} , ... , {τ}_{{N}_{samp}} ; λ ) ] \qquad ( 30 )$$

Once the stochastic process model is fitted to the estimated state variable, for example by obtaining an estimate of the latent vector λ*, then step 8 includes setting up a new state prior for the system, for example by setting up the conditional probability:

$$p ( {θ}_{j} = θ \vert {θ}_{j - 1} , ... , {θ}_{1} ; {τ}_{j} ; {λ}^{*} ) , \qquad ( 31 )$$

which is generated from the latent vector λ* and the joint probability distribution, and in this example is parameterized by the latent vector. In particular embodiments steps 7 and 8 may be performed only once per run of the apparatus (e.g., once per heating episode, in the microwave example), so that computational delay will not interrupt the subsequent real-time operation. In particular embodiments, steps 7 and 8 may be repeated, for example if the error between measurements and forecast states grows too large. For example, as illustrated in FIG. 4, if the difference between forecast states and measurements after step 11 (discussed below) becomes too large (e.g., the difference is greater than the sensor noise associated with the sensor capturing the images), then steps 7 and 8 may repeat.

Step 9 of the example implementation shown in FIG. 4 includes forecasting the next carrier state θⱼ*, where * represents an estimated quantity. for new inputs τⱼ given a set of previous states, using the conditional probability shown in equation 21 or 31. In particular embodiments, the initial estimation θᵢ* made in step 4 may be sufficiently accurate for a particular use case, and therefore steps 5-8 in FIG. 4 are replaced by a direct connection from step 4 to step 9.

Meanwhile, in the example implementation shown in FIG. 4 the system continues to collect more data samples (dⱼ,τⱼ), as shown in step 12 of the flowchart, and these data samples are used to in step 9 to forecast the next carrier state. For example, in step 9 the estimated value of θⱼ* may be estimated as the maximum a priori (MAP) solution that maximizes the probability of the data and the forecast:

$${θ}_{j}^{*} = arg max [ p ( {d}_{j} \vert θ , {τ}_{j} ) p ( {θ}_{j} = θ \vert {θ}_{j - 1}^{*} , ... , {θ}_{1}^{*} ; {τ}_{j} ; {λ}^{*} ) ] , \qquad ( 32 )$$

using equation (31) for the state conditional probability. However, particular embodiments may also compute statistics other than the MAP. Solving equation (32) is similar to applying a Bayesian Filter and can be numerically achieved in two steps: a forecast and an update of θⱼ* which are illustrated in steps 9 and 10 in FIG. 4. Particular embodiments may solve (32) in one or multiple steps, using any available algorithms and methods including, without limitation, numerical optimization, graphical networks, look-up tables, approximate or exact analytical expressions.

Step 11 of the example implementation shown in FIG. 4 uses the estimated value of the state variable θⱼ*, e.g., as obtained in (32) and all or part of the corresponding data (dⱼ,τⱼ), as well as data samples or parameters available at the time of the calculation, to compute a statistic of the load:

$${S}_{j}^{*} = F [ τ = {τ}_{j} , θ = {θ}_{j}^{*} , d = {d}_{j} ] , \qquad ( 33 )$$

The function F in (33) may be defined by an analytical expression or a computational procedure. As discussed above, the implementation of FIG. 4 uses statistical inference of the carrier state in calculating the statistics that depend on that state. For example, for turntable microwave data, particular embodiments may use the statistical estimate θⱼ* of the turntable angle to rotate a segmentation mask in order to calculate temperature statistics only for the food, and not of the image background. In that example, Sⱼ* may be represented as:

$${S}_{j}^{*} = F [ τ = {τ}_{j} , θ = {θ}_{j}^{*} , L ( x , y , τ = {τ}_{j} , θ = {θ}_{j} ) , T ( x , y ) = {T}_{j} ( x , y ) ] , \qquad ( 34 )$$

where T(x,y) represents an image or set of images, L(x,y,τ,θ) represents a state-dependent masking operator or function, and the masking operator or function for a given value of the state variable θ is given by:

$$L ( x , y , τ , θ ) = {R}_{L} [ {L}_{0} ( x , y ) , τ , θ ] , \qquad ( 35 )$$

where L₀(x,y) is an initial masking operator or function, and R_{L} is a transformation operator computable in real time. For example, R_{L} can be a turntable rotation operator as shown in equation 28. The initial mask can be obtained, for example, using a thresholding operation as described above, or as the output of an imaging algorithm. The initial mask L₀(x,y) may be one of the global parameters in step 1 of FIG. 4. Depending on the application, this initial step can be computationally intensive, and delay start of data collection. However, the mask transformations (35) are computationally light and will not significantly delay the subsequent processing.

As shown in FIG. 4, steps 9-12 may periodically repeated in order to update the estimate of the carrier state and thereby obtain updated statistics.

As discussed above, measurements may be based on image data of a load on a carrier, so that:

$$( {d}_{i} , {τ}_{i} ) = ( {I}_{i} ( x , y ) , {T}_{i} ( x , y ) , {D}_{i} ) , i = 1 , … , {N}_{samp} , \qquad ( 36 )$$

where I and T may denote various attributes such as RGB image intensity or temperature, (x,y) are coordinates within those images, and Dᵢ are any additional measurements collected with each sample. One or more components of (36) depend on values of the state variable θᵢ, for example:

$${I}_{i} ( x , y ) = R [ {I}_{0} ( x , y ) , {τ}_{i} , {θ}_{i} ] , \qquad ( 37 )$$

where I₀(x,y) is the initial or a reference image, and R is an arbitrary transformation operator. In this embodiment (37) may depend on additional parameters so long as those parameters are known and are independent of the state variable. In specific applications such as microwave ovens, the operator R can be a turntable rotation operator. In this example, the probability distribution p(d|θ,τ) is defined by the image I(x,y) so that:

$$p ( ( I ( x , y ) , T ( x , y ) , {D}_{i} ) \vert θ , τ ) ∼ f ( μ ( R [ {I}_{0} ( x , y ) , τ , θ ] , I ( x , y ) ) ) , \qquad ( 38 )$$

where I₀(x,y) is the reference image, ƒ is some positive function, and μ is a measure of a difference (or misfit) between the two images. Thus, equation 38 reflects that the estimation of the probability of the new image being equivalent to the initial image rotated by θ depends on the mismatch between the new image and the rotated initial image. One potential choice for μ yields:

$$p ( d \vert θ , τ ) = p ( I ( x , y ) \vert θ , τ ) ∼ exp [ - \frac{{‖ M [ I ( x , y ) - R [ {I}_{0} ( x , y ) , τ , θ ] ] ‖}_{2}^{2}}{2 {σ}_{I}^{2}} ] , \qquad ( 39 )$$

where σ_{I}² is an image-misfit variance and M is an image processing operator (such as a masking operator).

In particular embodiments, the input parameter τᵢ associated with data sample (dᵢ,τᵢ) and value of the state variable θᵢ may contain a temporal component that identifies the time at which the corresponding measurement was taken. (The actual time may be known accurately or approximately. For notational purposes, this section uses τᵢ as “time,” although in general the input parameter may be a combination of temporal and non-temporal parameters.) While the foregoing discussion assumes a scalar state variable, the techniques described herein extend to vector states, as well. In addition, in generally the techniques described herein may apply to uniformly and non-uniformly spaced sampling times τᵢ but for simplicity the forgoing discussion considers uniform spacing with τᵢ−τᵢ₋₁=Δτ≡const, i>0. A sequence (time series) may be represented as:

$${η}_{i} = {Δ}^{l} {θ}_{i} - {\sum }_{j = 1}^{d} {γ}_{j} {X}_{k}^{j} , i > l , \qquad ( 40 )$$

where{Xₖ^{j}}, j=1, . . . , d is a dictionary of deterministic signals (compare with (25)), and Δ^{l} is the lth order-finite differencing operator defined as

$${Δ}^{l} = Δ ∘ {Δ}^{l - 1} , {Δθ}_{i} = \frac{{θ}_{i} - {θ}_{i - 1}}{Δτ} . \qquad ( 41 )$$

The dictionary {Xₖ^{j}}, j=1, . . . , d may contain signals that are known to be present in state trajectories (e.g., harmonics, linear trends, etc.). Parameter l in (40) is a global parameter and is identified during design of the apparatus and may depend on the target application and physics of the underlying motion. However, for typical conveyor or turntable designs, as well as robotic navigation problems, suitable values can be l=1, 2 (compare with series (22)).

Equation 40 may be rewritten as the following recurring representation:

$${η}_{k} = G ( {η}_{k - 1} , … , {η}_{k - p} ; {ϵ}_{k - 1} , … , {ϵ}_{k - q} ; λ ) , {ϵ}_{k} ∼ N ( 0 ; {σ}_{ϵ}^{2} ) , \qquad ( 42 )$$

where G is an arbitrary function that can be evaluated in real time and parameterized by a latent parameter vector λ. Equation 42 may describe a wide variety of stochastic processes including non-stationary processes and processes with multiplicative noise when G is nonlinear, and additive Gaussian noise stationary and non-stationary processes when linear. Particular embodiments obtain λ* and the deterministic signal in (40) from the states θᵢ* (e.g., as estimated in step 4 of the example implementation shown in FIG. 4) by solving the following optimization problem (nonlinear least-squares regression):

$${γ}_{1} , … , γ d , {λ}^{*} = arg min \{ {𝔼}_{{ϵ}_{1} , … , {ϵ}_{{N}_{samp}}} [ {\sum }_{k = max ( p , q , l ) + 1}^{{N}_{samp}} {{σ}_{{η}_{k}}^{- 2} ( G ( {η}_{k - 1}^{*} , … , {η}_{k - p}^{*} ; {ϵ}_{k - 1} , … , {ϵ}_{k - p} ; λ ) - {η}_{k}^{*} )}^{2} ] \} \qquad ( 43 )$$

where ηₖ*=Δ^{l}θₖ*, −Σⱼ₌₁^{d}γⱼXₖ^{j} k>l depend on γ₁, . . . , γ_{d}, and the expectation is with respect to Nₛₐₘₚ samples of the Gaussian white process ϵₖ. Equation 43 is the optimal solver for the latent parameter vector λ for a Gaussian ηₖ. Although the latter may not be Gaussian for a nonlinear function G in (42), local normality may still be a permissible approximation. Alternatively, particular embodiments may use an arbitrary misfit other than the mean squared error in the right-hand side of (43). As an example, but without limitation, (42) can be a linear function:

$${η}_{k} = G ( {η}_{k - 1} , … , {η}_{k - p} ; {ϵ}_{k - 1} , … , {ϵ}_{k - p} ; λ ) = {\sum }_{j = 1}^{p} {β}_{j} {η}_{k - j} + {\sum }_{j = 1}^{q} {α}_{j} {ϵ}_{k - j} + {ϵ}_{k} , k = max ( p , q , l ) + 1 , … , \qquad ( 44 )$$

where the latent parameter vector is λ=(α₁, . . . , αₚ, β₁, . . . , β_{q}). Depending on the magnitudes of the estimated coefficients (that determine locations of the roots of characteristic polynomials) the recurrent formula (44) may define a stochastic non-stationary process, or a stationary ARMA process.

Once the parameter vector and the deterministic signal component of Δ^{l}θᵢ have been estimated by, for example, solving equation (43), particular embodiments use the recurrent expressions (42) or (44) and the finite difference equations (40,41) to forecast a value for the state variable θⱼ from the previous (in time) estimated values θⱼ₋₁, θⱼ₋₂, . . . , . For example, for both stationary autoregressive AR(p) processes and non-stationary processes defined by (44) when q=0, a forecast is made by direct substitution of known values into (44) and summation of finite differences in (40). From (44) with q=0, one obtains:

$$\tilde{{η}_{J}} = 𝔼 [ {η}_{j} \vert {η}_{j - 1}^{*} , … , {η}_{1}^{*} ] = {\sum }_{i = 1}^{min ( j - l - 1 , p )} {β}_{j} {η}_{j - i}^{*} \qquad ( 45 )$$

For q>1, even in the stationary case of ARMA(p,q) and MA(q), a prediction using (44) requires maintaining and summing an auxiliary time series, because a realization of the Gaussian white noise ϵₖ is now being inverted from observations (the Wiener-Kolmogorov prediction formula). However, the computational cost of such an operation is low. For example, for an MA(1) process (i.e., p=0, q=1 in a stationary process (44)) described in our defrosting example in (23), the result is:

$$\tilde{{η}_{J}} = 𝔼 [ {η}_{j} \vert {η}_{j - 1}^{*} , … , {η}_{1}^{*} ] = {\sum }_{i = 1}^{j - l - 1} {( - 1 )}^{i - 1} {α}_{1}^{i} {η}_{j - i}^{*} \qquad ( 46 )$$

A forecast of \tilde{θ}ⱼ= [symbol] [θⱼ|θⱼ₋₁*, . . . , θ₁*] is obtained from [symbol] , ηⱼ₋₁*, . . . , η₁* by summation of (40).

Variance of the forecast for any stationary of non-stationary process (44) can be estimated as:

$$Var [ ] = {\sum }_{i = 1}^{p} {β}_{j}^{2} Var [ {η}_{j - i}^{*} ] + {σ}_{ϵ}^{2} \qquad ( 47 )$$

Regarding the first sum in (47), ηⱼ₋₁* are derived from estimated state variables that are not directly observed but inferred from noisy data in (32) and hence are uncertain. As before, Var[ [symbol] ] is obtained by summation of (40). For the prior (31) one obtains:

$$log p ( {θ}_{j} = θ \vert {θ}_{j - 1}^{*} , … , {θ}_{j - 1}^{*} ; {τ}_{j} ; {λ}^{*} ) = const - \frac{{( θ - )}^{2}}{2 Var [ ]} \qquad ( 48 )$$

For a nonlinear G the Gaussian assumption is not valid but may be permissible after a linearization. With the new prior (48) Bayesian inference (31) becomes:

$${θ}_{j}^{*} = arg min [ - log p ( {d}_{j} \vert θ , {τ}_{j} ) + \frac{{( θ - )}^{2}}{2 Var [ ]} ] , \qquad ( 49 )$$

Or, for example, using the observational model (39):

$${θ}_{j}^{*} = arg min [ \frac{{‖ M [ I ( x , y ) - R [ {I}_{0} ( x , y ) , τ , θ ] ] ‖}_{2}^{2}}{2 {σ}_{I}^{2}} + \frac{{( θ - )}^{2}}{2 Var [ ]} ] . \qquad ( 50 )$$

Var[θⱼ*] is obtained from (49) and (50) as the inverse Hessian (reciprocal of the second derivative when θ is scalar) of the objective function with respect to the state variable evaluated at the minimum. The state variable variance in (46) is used for constructing the next forecasting prior (47).

In the context of the example implementation shown in FIG. 4, the immediately foregoing discussion replaces the inference of state evolution law (30) with a least-squares fitting (42,43) or (44,43), impacting step 7 of FIG. 4. The discussion replaces the conditional state probability formula (31) with (47), impacting steps 8 and 9 of FIG. 4. The discussion replaces the general state inference (32) with more specific optimization problems (48) or (49), impacting steps 10 and 11 of FIG. 4.

Certain examples in this disclosure describe estimating carrier motion in order to accurately update a segmentation mask for a load, among other purposes. A “segmentation mask” as used in this disclosure may take the typical form of a pixel-based discrimination between load and background (e.g., carrier, etc.). However, this disclosure contemplates that, in general, the references to a segmentation mask generally include any suitable discriminator between load and background.

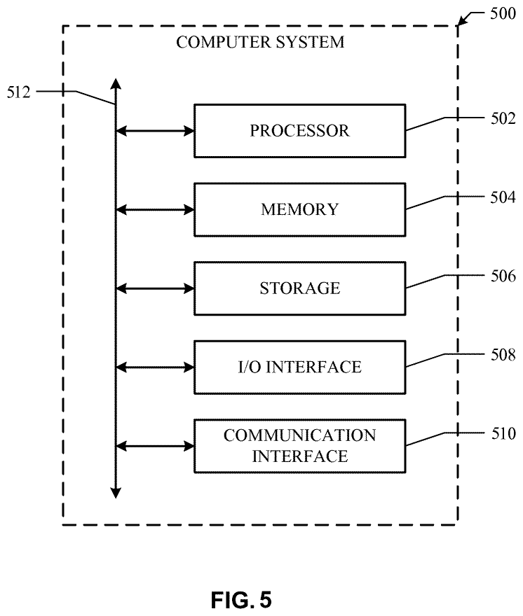

Particular embodiments may repeat one or more steps of FIG. 1 or of FIG. 4, where appropriate. Although this disclosure describes and illustrates particular steps of FIG. 1 and of FIG. 4 as occurring in a particular order, this disclosure contemplates any suitable steps of FIG. 1 or of FIG. 4 occurring in any suitable order, respectively. Moreover, although this disclosure describes and illustrates particular components, devices, or systems carrying out particular steps of FIG. 1 or of FIG. 4, such as the computer system of FIG. 5, this disclosure contemplates any suitable combination of any suitable components, devices, or systems carrying out any suitable steps of FIG. 1 or of FIG. 4. Moreover, this disclosure contemplates that some or all of the computing operations described herein, including the steps of FIG. 1 or of FIG. 4, may be performed by circuitry of a computing device, for example the computing device of FIG. 8, by a processor coupled to non-transitory computer readable storage media, or any suitable combination thereof.

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
accessing an initial image of a load on a moving load carrier, the initial image of the load having been captured at an initial time;
accessing a subsequent image of the load on the moving load carrier, the subsequent image having been captured at a subsequent time;
generating a transformed set of images comprising a first initial image and a first subsequent image, wherein creating the transformed set of images comprises transforming at least one of: (1) the initial image to the first initial image or (2) the subsequent image to the first subsequent image according to a motion profile of the load carrier from the initial time to the subsequent time; and
estimating a motion of the load carrier from the initial time to the subsequent time based on minimizing a difference between the first subsequent image of the load and the first initial image of the load.

2. The method of claim 1, wherein estimating the motion of a load carrier comprises estimating one or more of (1) a rotation of the load carrier or (2) a motion of at least a portion of the load carrier along one or more predetermined trajectories.

3. The method of claim 1, wherein estimating the rotation of a load carrier comprises estimating one or more of (1) a periodic motion of at least a portion of the load carrier or (2) a translation of at least a portion of the load carrier.

4. The method of claim 1, further comprising estimating the motion of the load carrier by minimizing an objective function that is based on (1) the difference between the first subsequent image of the load and the first initial image of the load and (2) a likelihood distribution of the motion of the load carrier at the subsequent time.

5. The method of claim 4, further comprising estimating the motion of the load carrier by minimizing an objective function that includes an image noise model.

6. The method of claim 4, wherein the likelihood distribution of the motion of the load carrier at the subsequent time is based on an estimated rate of motion of the load carrier.

7. The method of claim 6, wherein the estimated motion rate of the load carrier is based on a plurality of images of the load on the moving load carrier, each of the plurality of images have been captured at a corresponding time between the initial time and the subsequent time.

8. The method of claim 7, wherein the estimated motion rate of the load carrier and the likelihood distribution of the motion of the load carrier at the subsequent time are each based on an estimated variance of an acceleration of the load carrier.

9. The method of claim 4, wherein the likelihood distribution of the motion of the load carrier at the subsequent time is based on modeling rotational dynamics of the load carrier as a stochastic process.

10. The method of claim 9, further comprising determining, based on the modeled stochastic process, a temporal deviation of the rotation rate, the deviation comprising a seasonal signal, a trend signal, and a residual signal.

11. The method of claim 4, wherein them motion of the load carrier comprises a rotation of the load carrier, and the likelihood distribution comprises an initial likelihood distribution, the method further comprising:
accessing a plurality of additional images, each captured at a time after the subsequent time;
determining whether the initial image, the subsequent image, and the plurality of additional images comprise sufficient data to define a state evolution of the load carrier; and
in response to a determination that there is sufficient data to define a state evolution of the load carrier, then:
determining, based on the defined state evolution, an updated likelihood distribution of the rotation of the load carrier;
accessing a plurality of images of the load carrier captured during a period of time; and
determining, based on the updated likelihood distribution and the plurality of images of the load carrier, a rotation of the load carrier during the period of time.

12. The method of claim 1, wherein the initial image and the subsequent image are captured by an imaging apparatus comprising one or more of:
one or more RBG cameras; or
one or more thermal cameras

13. The method of claim 1, further comprising:
accessing an initial segmentation mask of the load; and
determining, based on the initial segmentation mask and the estimated motion of the load carrier, an updated segmentation mask for the load.

14. The method of claim 13, wherein the load comprises a food item in a microwave and the motion of the load carrier comprises a rotation of the load carrier.

15. The method of claim 13, further comprising calculating, based upon the updated segmentation mask for the load, one or more statistics of the load.

16. The method of claim 15, wherein the one or more statistics of the load comprise one or more of: a temperature distribution within the load, a mean temperature of the load, a median temperature of the load, or a statistic of the load that is based on a determined temperature of the load.

17. The method of claim 1, wherein the load comprises a food item in a microwave.

18. A system comprising:
one or more non-transitory computer readable storage media storing instructions; and one or more processors coupled to the non-transitory computer readable storage media, the one or more processors operable to execute the instructions to:
access an initial image of a load on a moving load carrier, the initial image of the load having been captured at an initial time;
access a subsequent image of the load on the moving load carrier, the subsequent image having been captured at a subsequent time;
generate a transformed image set comprising a first initial image and a first subsequent image, wherein creating the transformed image set comprises transforming at least one of: (1) the initial image to the first initial image or (2) the subsequent image to the first subsequent image according to a motion profile of the load carrier from the initial time to the subsequent time; and
estimate a motion of the load carrier from the initial time to the subsequent time based on minimizing a difference between the subsequent image of the load and the initial image of the load.

19. The system of claim 18, wherein the one or more processors are further operable to estimate the motion of the load carrier by minimizing an objective function that is based on (1) the difference between the first subsequent image of the load and the first initial image of the load and (2) a likelihood distribution of the motion of the load carrier at the subsequent time.

20. The system of claim 19, wherein the likelihood distribution of the motion of the load carrier at the subsequent time is based on modeling rotational dynamics of the load carrier as a stochastic process.

21. The system of claim 19, wherein the motion of the load carrier comprises a rotation of the load carrier, and the likelihood distribution comprises an initial likelihood distribution, further comprising one or more processors operable to execute the instructions to:
access a plurality of additional images, each captured at a time after the subsequent time;
determine whether the initial image, the subsequent image, and the plurality of additional images comprise sufficient data to define a state evolution of the load carrier; and
in response to a determination that there is sufficient data to define a state evolution of the load carrier, then:
determine, based on the defined state evolution, an updated likelihood distribution of the rotation of the load carrier;
access a plurality of images of the load carrier captured during a period of time; and
determine, based on the updated likelihood distribution and the plurality of images of the load carrier, a rotation of the load carrier during the period of time.

22. One or more non-transitory computer readable storage media storing instructions and coupled to one or more processors that are operable to execute the instructions to:
access an initial image of a load on a moving load carrier, the initial image of the load having been captured at an initial time;
access a subsequent image of the load on the moving load carrier, the subsequent image having been captured at a subsequent time;
generate a transformed image set comprising a first initial image and a first subsequent image, wherein creating the transformed image set comprises transforming at least one of: (1) the initial image to the first initial image or (2) the subsequent image to the first subsequent image according to a motion profile of the load carrier from the initial time to the subsequent time; and
estimate a motion of the load carrier from the initial time to the subsequent time based on minimizing a difference between the subsequent image of the load and the initial image of the load.

23. The media of claim 22, wherein the one or more processors are further operable to execute the instructions to estimate the motion of the load carrier by minimizing an objective function that is based on (1) the difference between the first subsequent image of the load and the first initial image of the load and (2) a likelihood distribution of the motion of the load carrier at the subsequent time.

24. The media of claim 23, wherein the likelihood distribution of the motion of the load carrier at the subsequent time is based on modeling rotational dynamics of the load carrier as a stochastic process.

25. The media of claim 23, wherein the motion of the load carrier comprises a rotation of the load carrier, and the likelihood distribution comprises an initial likelihood distribution, the one or more non-transitory computer readable storage media storing further instructions and coupled to one or more processors that are operable to execute the instructions to:
access a plurality of additional images, each captured at a time after the subsequent time;
determine whether the initial image, the subsequent image, and the plurality of additional images comprise sufficient data to define a state evolution of the load carrier; and
in response to a determination that there is sufficient data to define a state evolution of the load carrier, then:
determine, based on the defined state evolution, an updated likelihood distribution of the rotation of the load carrier;
access a plurality of images of the load carrier captured during a period of time; and
determine, based on the updated likelihood distribution and the plurality of images of the load carrier, a rotation of the load carrier during the period of time.
